(19) United States
(12) Patent Application Publication
(10) Pub. No.: US 2023/0249737 A1
(43) Pub. Date: Aug. 10, 2023

(54) STEERING COLUMN FOR A MOTOR VEHICLE

(71) Applicants: thyssenkrupp Presta AG, Eschen (LI); thyssenkrupp AG, Essen (DE)

(72) Inventors: Adam CASE, Indianapolis, IN (US); Charles FABROS, Indianapolis, IN (US)

(73) Assignees: thyssenkrupp Presta AG, Eschen (LI); thyssenkrupp AG, Essen (DE)

(21) Appl. No.: 18/014,542

(22) PCT Filed: Jul. 5, 2021
(86) PCT No.: PCT/EP2021/068490

§ 371 Date: Jan. 5, 2023

(30) Foreign Application Priority Data
Jul. 8, 2020 (DE) 10 2020 208 533.1

(51) Int. Cl. B62D 1/184; B62D 1/19

(52) U.S. Cl. CPC B62D 1/184; B62D 1/19

(57) ABSTRACT

A steering column for a motor vehicle may include an adjusting unit in which a steering spindle is mounted so as to be rotatable about a longitudinal axis extending in a longitudinal direction, a holding unit in which the adjusting unit is adjustably held, and a fixing device with a first clamping device and a second clamping device for the releasable fixing of the adjusting unit relative to the holding unit. The clamping devices are operatively connected to a clamping lever that can be selectively brought into a fixed position or into a released position. The clamping devices may be operatively arranged in parallel.

### PRIOR ART

The invention relates to a steering column for a motor vehicle, comprising an adjusting unit in which a steering spindle is mounted so as to be rotatable about a longitudinal axis extending in the longitudinal direction, a holding unit in which the adjusting unit is adjustably held, and a fixing device with a first clamping device and a second clamping device for the releasable fixing of the adjusting unit relative to the holding unit, wherein the clamping devices are operatively connected to a clamping lever which can be selectively brought into a fixed position or into a released position.

In order to adapt the steering wheel position of the steering wheel to the driver's position, the steering wheel being attached to the rear end of the steering spindle relative to the direction of travel, in a generic adjustable steering column it is known to adjust the adjusting unit, in which the steering spindle is mounted, relative to the holding unit which is fixed to the vehicle body.

In normal driving mode, due to the fixing device being located in the fixed or clamped position, the adjusting unit is fixed so as to be braced on the holding unit, so that the steering wheel position is secured. For setting the steering wheel position, the fixing device can be brought into a released or release position by actuating a clamping lever for the releasing, whereby the bracing is removed and the adjusting unit can be adjusted relative to the holding unit into the desired steering wheel position. The adjustment can be fixed again by reverse actuation of the clamping lever.

For the height adjustment, the adjusting unit can be pivotable in relation to the holding unit relatively about a vertical adjustment axis located horizontally and transversely to the longitudinal axis. Alternatively or in combination, a longitudinal adjustment can be provided by the adjusting unit being adjustable in the longitudinal direction in a telescopic manner relative to the holding unit.

A steering column of the type mentioned in the introduction is disclosed in DE 10 2014 111 606 B3. This steering column has an adjusting unit which is adjustable in the longitudinal and vertical direction and which is arranged between two side cheeks of a carrier unit of the holding unit fixed to the vehicle body. The fixing device disclosed therein has a clamping lever which is operatively connected to a first clamping device and a second clamping device. In order to fix the steering column again after setting the steering wheel position, the clamping lever is moved with a manual clamping movement by rotating about the clamping axis from the released position in the direction of the fixed position. In this case, initially the first clamping device is activated and the adjusting unit is clamped and braced non-positively between the side cheeks of the carrier unit by the clamping stroke exerted by the clamping device. A locking element which is also braced by the holding unit is then moved into holding engagement with the carrier unit by continuing the clamping movement, in order to generate an advantageously greater holding action in the vertical direction in the event of a crash. The actuation of the two clamping devices in series which is required firstly in order to brace the adjusting unit and the locking element with the carrier unit, and then in order to secure the locking element to the carrier unit, however, requires a relatively long actuating path. For the fixing, the clamping lever has to be pivoted by a correspondingly large actuating angle around the clamping axis. As a result, a relatively large space is required for the movement of the clamping lever. Moreover, the operation can be perceived as awkward and uncomfortable.

In view of the problem described above, it is an object of the present invention to enhance the ease of operation of the fixing device and to reduce the required installation space in a steering column of the aforementioned type.

### SUMMARY OF THE INVENTION

This object is achieved according to the invention by the steering column having the features of claim 1. Advantageous developments emerge from the subclaims.

In a steering column for a motor vehicle, comprising an adjusting unit in which a steering spindle is mounted to as to be rotatable about a longitudinal axis extending in the longitudinal direction, a holding unit in which the adjusting unit is adjustably held, and a fixing device with a first clamping device and a second clamping device for the releasable fixing of the adjusting unit relative to the holding unit, wherein the clamping devices are operatively connected to a clamping lever which can be selectively brought into a fixed position or into a released position, according to the invention it is provided that the clamping devices are operatively arranged in parallel.

The adjusting unit comprises a casing tube, also denoted as the inner casing or inner casing tube, in which the steering spindle is rotatably mounted. The holding unit can comprise a carrier unit which is designed for fastening the steering column to a vehicle body. The adjusting unit can be held on the carrier unit so as to be adjustable in the longitudinal and/or vertical direction, for example between two side cheeks opposing one another transversely to the longitudinal axis. The holding unit can have an outer casing, also denoted as the outer casing tube, casing unit or guide box, which is held by the carrier unit so as to be adjustable in the vertical direction and in which the adjusting unit can be received so as to be adjustable in the longitudinal direction.

The fixing device, also denoted as the securing device, can be switched, for example by manual actuation of a clamping lever or actuating lever, between a fixed or clamped position in which the adjusting unit is secured in a set operating position relative to the holding unit and a released or release position in which the adjusting unit is adjustable relative to the holding unit for setting the steering wheel position.

According to the invention, the first clamping device and the second clamping device, denoted in their entirety as the clamping device or the two clamping devices, are both connected to the clamping lever. In this case, an essential difference from the prior art is that they are attached to the clamping lever in parallel in terms of actuation, i.e. adjacent to one another in the flux of force. Thus with an actuation of the clamping lever, for example, in order to secure or to release the fixing device, the two clamping devices are actuated jointly by the actuating force input into the clamping lever, so that they are braced or released at the same time. The operative parallel arrangement is intended to be understood to mean that the clamping devices can exert their respective clamping force independently of one another but simultaneously, by being actuated at the same time for bracing the steering column. According to the invention, such a parallel actuation in which the two clamping devices cover their actuating paths in parallel, driven by the clamping lever, takes place such that they exert their clamping action in parallel. The advantage of a shorter actuating path as a whole can be implemented by the parallel actuating paths, in comparison with the arrangement of the clamping devices in series in the prior art, the actuating paths thereof being added together during the clamping or releasing. As a result, the space required for the movement for the actuation can be reduced and a more convenient operation can be permitted.

The operative direction of the clamping force which, for example, denotes the spatial direction of a clamping stroke, for example transversely to the longitudinal axis for clamping the adjusting unit to the holding unit, can be oriented in the same spatial direction but can also be different for the clamping devices.

In an advantageous development, the first clamping device has a first clamping characteristic and the second clamping device has a second clamping characteristic, wherein the first clamping characteristic and the second clamping characteristic differ from one another. The clamping characteristic is the connection between the actuating path, i.e. the angle about which the clamping lever is rotated, and the generated clamping stroke. In other words, the clamping characteristic denotes the transmission ratio of the actuating path of the clamping lever to the clamping stroke which is generated by the clamping device. The clamping characteristic can accordingly relate to the force-path ratio.

In an advantageous development, it can be provided that the maximum clamping stroke of the first clamping device is smaller or larger than the maximum clamping stroke of the second clamping device, wherein the two clamping devices have the same actuating path. Due to this development, the clamping stroke can be structurally adapted to the corresponding functions of the respective clamping device so that an improvement in the operating behavior is achieved.

Preferably, the first clamping device and the second clamping device have different operating principles from one another. In other words, the first clamping device has a first operating principle, i.e. is based on such an operating principle, and the second clamping device has a second operating principle, i.e. is based on such an operating principle, wherein the first operating principle and the second operating principle are different, i.e. deviate from one another. The respective operating principle can result from the design of the clamping device, for example the first clamping device can have a tilting pin mechanism and the other clamping device can have a wedge plate mechanism, or the like. As a result, the specific advantageous properties of the differently operating clamping mechanisms can be used in an optimized manner, for example regarding different clamping characteristics and/or installation space requirements, and the like.

Preferably, the first clamping device cooperates with the holding unit for bracing the adjusting unit. The first clamping device in this case serves for the releasable clamping of the adjusting unit on the holding unit. For example, the holding unit can comprise a carrier unit which has two side cheeks extending downwardly in the vertical direction and opposing one another relative to the longitudinal axis, the adjusting unit being arranged therebetween. The first clamping device can preferably have a stroke-generating mechanism which acts from the outside on the side cheeks and pushes these side cheeks together in the fixed position and braces them with the adjusting unit, for example clamps them in a non-positive manner.

It is possible that the second clamping device cooperates with a locking element for locking the adjusting unit. The locking element can generate a coupling of the adjusting unit to the holding unit in addition to the first clamping device, for example by an additional positive connection, for engaging an energy absorption device or the like. According to the invention, the locking element can already be blocked by the parallel clamping devices, for example when fixed by the second clamping device, whilst the adjusting unit can be clamped by the first clamping device in the holding unit. As a result, advantageously a short actuating path of the fixing device can be implemented and less installation space is required.

It is advantageous that the locking element is configured to engage an energy absorption device between the adjusting unit and the holding unit. In the event of a vehicle crash, in order to reduce the risk of injury for the vehicle occupants by a controlled braking of a body striking the steering wheel, it is known to engage an energy absorption device between the adjusting unit and the holding unit which in normal operation are connected together by the fixing device but in the event of a crash can be pushed toward one another by overcoming the holding force. This energy absorption device can absorb the introduced kinetic energy by plastic deformation of an energy absorption element, for example by tearing open a tear tab or distorting or squeezing an elongated deformation element, for example a flexible wire or flexible strip.

The energy absorption device is preferably operatively arranged between the adjusting unit and the holding unit. “Operatively” refers here to the flux of force in the case of a relative movement due to the action of a high relative force in the event of a crash. In an advantageous, particularly preferred variant, the energy absorption device is arranged operatively and spatially between the adjusting unit and the holding unit.

For engaging the energy absorption device, it can be provided that the locking element is supported on the holding unit and can be brought into engagement with an engagement element attached to the adjusting unit. An energy absorption element of the energy absorption device can be engaged between the engagement element and the adjusting unit, for example. The locking element can preferably be supported in the longitudinal direction on the holding unit and, when the fixing device is secured by the second clamping device, can be brought into engagement with complementary positive connecting elements of the engagement element to form a positive connection acting in the longitudinal direction. To this end, it is advantageous that the engagement element has a toothed plate and the locking element has a toothed block which have corresponding toothings which can be positively brought into engagement. In the event of a crash, the non-positive clamping action of the first clamping device can be overcome and the adjusting unit slips through relative to the holding unit in the longitudinal direction. In this case, the engagement element is positively braced with the locking element by the second clamping device and is supported thereby on the holding unit counter to the relative movement of the adjusting unit. As a result, the engagement element is moved by deformation of the energy absorption element, for example a flexible strip or the like, relative to the adjusting unit, whereby energy is absorbed. The functional reliability of the energy absorption device is enhanced by the invention. It is particularly advantageous that, due to the parallel arrangement according to the invention of the two clamping devices, the energy absorption device is always securely engaged and active when the steering wheel position is fixed. This is advantageous relative to the arrangement in series known from the prior art, in which a locking element is locked to the holding unit by the second clamping device only after the adjusting unit is clamped by the first clamping device. This separation of the clamping and positive locking represents a functional separation since each of the two clamping devices undertakes only one of the two functions and can be correspondingly structurally adapted thereto and namely advantageously without involving compromises as in the solutions known from the prior art. By the gain in safety, therefore, the arrangement according to the invention is better suited for activating an energy absorption device.

It is possible that the actuating lever is connected to a clamping bolt. In this arrangement, which is known per se, the clamping bolt extends in the direction of the clamping axis, about which it is mounted so as to be rotatably movable relative to the holding unit. The actuation of the fixing device for the fixing and releasing can take place by manual or motorized rotation of the clamping bolt about the clamping axis. Preferably, the clamping bolt can extend transversely to the longitudinal axis through the holding device, for example through two side cheeks, the adjusting unit being able to be clamped therebetween.

It is advantageous that a clamping device has a stroke-generating mechanism. A stroke-generating mechanism, also denoted as a stroke-generating gearing, serves for converting a rotation of the clamping bolt about the clamping axis by an actuating angle into an axial clamping stroke. The actuating angle corresponds in this case to an arcuate actuating path of the clamping lever. By the parallel arrangement according to the invention—as described above—the actuating angle of the clamping devices overlap, so that by means of the invention the total actuating angle required for actuating all of the clamping devices advantageously can be reduced. In an advantageous development, the actuating angle between the clamped position and the release position is less than or equal to 60°, preferably less than or equal to 50°, and particularly preferably less than or equal to 45°. Due to the parallel arrangement according to the invention, such small actuating angles can be implemented without having to tolerate losses in the clamping and locking.

Preferably, the actuating angle is greater than or equal to 20°. It has been shown in tests that vehicle drivers perceive actuating angles of greater than or equal to 20° as haptically more pleasant than actuating angles of less that 20°.

By the clamping stroke, for example, the side cheeks can be pressed together and braced non-positively against the adjusting unit, and the locking element can be in positive engagement with the engagement element. An advantage of the invention here is that the clamping devices can have, independently from one another, different transmission ratios which in each case specify the ratio of the actuating path to the clamping stroke or the ratio between the actuating force and the exerted clamping force. Due to the invention, clamping devices with different transmission ratios can be optimized functionally, wherein an advantageously short overall actuating path of the fixing device is possible.

An advantageous development is that a clamping device has a tilting pin device. A tilting pin device, which is known per se, is a stroke-generating gearing with a tilting pin clamping mechanism or gearing. This comprises a stroke-generating plate or support plate which is rotatably movably mounted about the clamping axis relative to a pressure plate, wherein one or more elongated pin-shaped tilting pins are arranged so as to be distributed over the periphery between corresponding axial bearing points on the pressure plate or stroke-generating plate, and are supported against the axially opposing front faces of the stroke-generating plate and pressure plate such that, due to a relative rotation by an actuating angle, they can be brought from a resting position, which is inclined relative to the clamping axis and which corresponds to the released position, into an extended position which is located approximately parallel to the clamping axis and which corresponds to the fixed position in the case of a maximum stroke of the clamping device.

The stroke-generating plate can be attached to the first clamping device fixedly in terms of rotation and axially fixed to the clamping bolt and the pressure plate can be supported axially and fixedly in terms of rotation on the holding unit, specifically from the outside on a side cheek. Advantages of a tilting pin device are an efficient force transmission and a force-path transmission perceived as haptically pleasant when clamping the fixing device.

A defined transmission ratio can be implemented by the dimensioning and arrangement of the tilting pins. In particular, a high transmission ratio with a large clamping force can be implemented in the vicinity of the so-called dead center position or extended position point in which the tilting pins are located parallel to the clamping axis in the case of the maximum possible stroke.

In the dead center position or extended position point, the actuating force passes through a minimum point or a turning point so that a haptically clearly perceptible snapping-in or latching-in of the fixing device can be implemented, by a stable clamped position at the end of the actuating angle in the fixing device being able to be predetermined just behind the extended position point, for example by an end stop of the clamping lever. This perceived latching-in indicates when the stable clamped position is reached and the actuation is particularly clear and secure, wherein due to the parallel arrangement according to the invention it is ensured that the second clamping device is also correctly braced when the first clamping device, which is configured as a tilting pin device, is latched in the fixed position.

An advantageous embodiment of the invention provides that the tilting pin gearing has a stable clamped position in which the stroke-generating plate and the pressure plate are rotated relative to one another beyond the maximum stroke of the tilting pin device, wherein the stop means are configured such that in the stable clamped position they strike against one another in the peripheral direction and block a further rotation beyond the stable clamped position. By the reaction of the clamping force or tensioning force exerted by the stroke, a restoring force oriented counter to the rotation for the fixing acts on the stroke-generating plate and pressure plate. With the maximum stroke when the tilting pins are located in the dead center position or extended position, the clamping force acts axially in the direction of the tilting pins, whereby an unstable state is generated. Even a slight disruption could lead to the clamping device being moved back automatically again into the released position by the restoring force. In order to secure the stroke-generating position and thereby the fixed position permanently, according to the invention it is made use of the fact that when the extended position is exceeded by further rotation, the restoring force this time acts in the direction of rotation for the fixing, and the stroke-generating plate and pressure plate continue to rotate automatically. After the extended position is exceeded, a further relative rotation is blocked by the stop means. By the restoring force acting on the stop, a stable state is generated in which the stroke-generating plate and the pressure plate are held relative to one another. As the actuating force required for the rotation and the fixing increases as far as the extended position, and then the acting restoring force brings about the further rotation as far as the stop, a latching point is defined, which has to be overcome during the fixing and which safely and clearly indicates by a latching-in or snapping-in that the stable clamped position is reached. By making use of the dead center position or extended position specific to the tilting pin gearing, a pleasant operating feel can be implemented with a manual actuation via a clamping lever. In other words, a so-called “latching feeling” can be generated since the operating force drops significantly after the dead center position or extended position is exceeded, and the operating force changes direction, i.e. a change in sign of the operating force value takes place. Moreover, the latching point can be implemented with less wear than in other designs of latching devices.

The stop means can comprise stop surfaces which can be brought into contact with one another in the peripheral direction, in the direction of rotation for fixing, and which are configured corresponding to one another on the stroke-generating plate and pressure plate, on the tilting pins and on the stroke-generating plate or the pressure plate. For example, the bearing pockets which are configured as recesses can be designed such that they permit only a small limited tilting of the tilting pins after the extended position is reached, so that the tilting pins form positive connecting elements. Alternatively or additionally, the stroke-generating plate and the pressure plate in each case can have a stop portion with one respective stop surface which can be brought into operative connection with one another for providing a stop situation in which the pressure plate and the stroke-generating plate cannot be rotated further in this rotational direction, i.e. a further rotation in this rotational direction is prevented by the stops.

Preferably, the tilting pin device has exactly two or exactly three or exactly four tilting pins. These tilting pins can preferably be arranged so as to be distributed equally or unequally over the periphery.

It can be advantageously provided that a clamping device has a cam-connecting link plate device. For example, the second clamping device can have such a stroke-generating mechanism, which is known as a cam device or cam clamping device for bracing steering columns. This stroke-generating mechanism has a stroke-generating plate configured as a cam plate with axially protruding cams and a pressure plate which is configured as a connecting link plate and which is complementary thereto. The connecting link plate has a connecting link contour with a circular cam path axially facing the cam plate, with sliding slopes or sliding ramps rising in a wedge-shaped manner in the peripheral direction on which the cams of the cam plate can slide in the peripheral direction with a relative rotation of the cam plate and the connecting link plate. As a result, by a relative rotation, the cam plate and connecting link plate can be axially lifted away from one another in the direction of the clamping axis, whereby a clamping stroke is generated. Such a cam-connecting link plate device can be implemented in a manner which is particularly compact, simple and functionally reliable and can provide a large clamping stroke. Preferably, the clamping stroke is greater than or equal to 2 mm, quite particularly preferably greater than or equal to 3 mm.

In the invention, the cam plate can be attached fixedly in terms of rotation to the clamping lever or clamping bolt so as to be supported axially, and the connecting link plate can be fixedly attached to a locking element relative to the rotation of the clamping lever. By the relative rotation of the clamping lever for fixing the fixing device, for example, the locking element can perform an axial clamping stroke relative to the clamping axis, and thereby be braced in engagement with the engagement element of the energy absorption device.

In an advantageous development, it is possible that a pressure plate supporting a tilting pin of the first clamping device, which is configured as a tilting pin device, is coupled to a connecting link plate of the second clamping device, which is configured as the cam-connecting link plate device, fixedly in terms of rotation relative to the clamping axis and/or a stroke-generating plate of the first clamping device is connected fixedly in terms of rotation to the clamping lever which is coupled fixedly in terms of rotation to a cam plate of the second clamping device. In this combination according to the invention of a tilting pin device as the first clamping device and a cam-connecting link plate device as the second clamping device, the above-described specific advantages of both designs can be used in an optimized manner. As the stroke-generating plate of the tilting pin device and the cam plate of the cam-connecting link plate device are coupled together fixedly in terms of rotation relative to the clamping axis and to the clamping lever, the clamping devices are arranged in parallel and are actuated at the same time by the clamping lever during the fixing or releasing. In this case, the two clamping devices exert a clamping stroke axially in the direction of the clamping axis, and namely on the pressure plate of the tilting pin device or the connecting link plate of the cam-connecting link plate device. By the different transmission ratios, an axial relative movement can occur between the stroke-generating plate and cam plate and/or between the pressure plate and connecting link plate during the bracing and releasing. This relative movement can be compensated by a relatively displaceable arrangement relative to the clamping axis, so that for example a positive connection is implemented regarding the relative rotation, but a linear axial guidance is implemented in the direction of the clamping axis.

It can be provided that the connecting link plate and the pressure plate are braced resiliently against one another. As a result, play can be compensated and noise development reduced.

### DESCRIPTION OF THE DRAWINGS

Advantageous embodiments of the invention are described in more detail hereinafter with reference to the drawings. In detail:

FIG. 1 shows a steering column according to the invention in a schematic perspective view,

FIG. 2 shows the steering column according to FIG. 1 in a partially exploded state,

FIG. 3 shows a fixing device according to the invention of the steering column according to FIGS. 1 and 2 in a schematic exploded view,

FIG. 4 shows a cross section A-A through the steering column according to FIG. 1 in the fixed position,

FIG. 5 shows a perspective detailed view of the steering column according to FIG. 1 in the fixed position,

FIG. 6 shows a cross section through the steering column as in FIG. 4 in the released position,

FIG. 7 shows a perspective detailed view of the steering column as in FIG. 5 in the released position.

### EMBODIMENTS OF THE INVENTION

In the various figures, parts which are the same are always provided with the same reference signs and thus are generally cited or mentioned only once in each case.

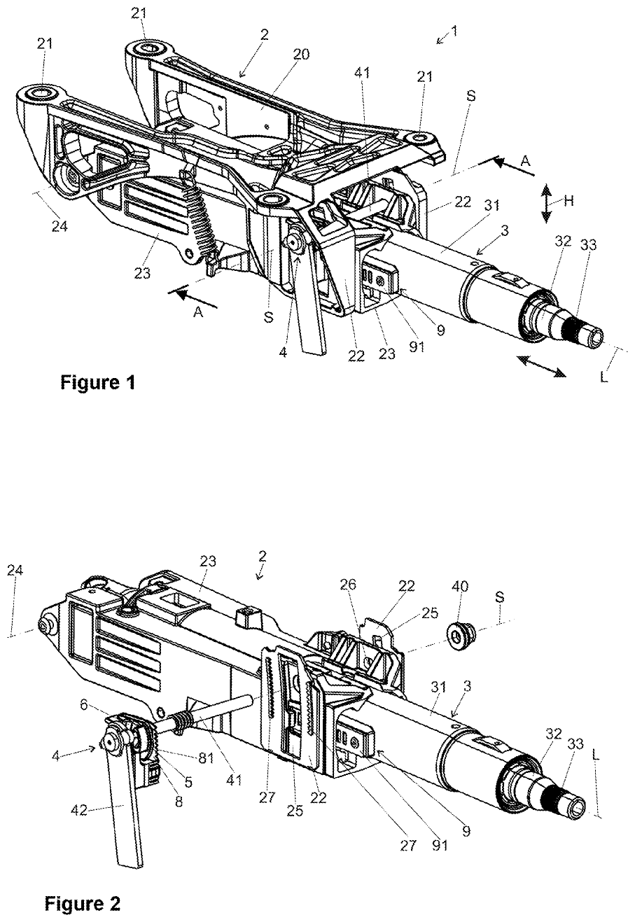

FIGS. 1 and 2 show in a perspective view obliquely from the rear left—relative to the direction of travel of a motor vehicle, not shown here—a steering column 1 which has a holding unit 2. This holding unit comprises a carrier unit 20, which has fastening means 21 for connecting to the body of the motor vehicle, not shown, for example fastening openings as shown. Two opposing side cheeks 22 extend downwardly from the carrier unit 2.

A casing unit 23, also denoted as the outer casing or guide box, is received between the side cheeks 22. The carrier unit 20 and the casing unit 23 form components of the holding unit 2 within the meaning of the invention.

The casing unit 23 is shown exposed without the carrier unit 20 in FIG. 2 for improved clarity, apart from the side cheeks 22. An adjusting unit 3 has a steering spindle 32 which is rotatably mounted in an inner casing tube, an inner casing or, in short, a casing tube 31 so as to be rotatable about its longitudinal axis L extending in the longitudinal direction. At the end on the driver's side to the rear relative to the direction of travel, the steering spindle 31 has a fastening portion 33 for attaching a steering wheel, not shown. The adjusting unit 3 is received with the casing tube 31 so as to be longitudinally displaceable in a casing unit 23 in the longitudinal direction, i.e. in the direction of the longitudinal axis L, as indicated schematically by a double arrow.

The casing unit 23 is pivotably mounted on the carrier unit 2 about a pivot axis 24 located transversely to the longitudinal axis L. As a result, for setting the vertical position of the steering wheel, the casing unit can be moved up and down together with the adjusting unit 3 between the side cheeks 22 relative to the carrier unit 2 in the vertical direction H by being pivoted about the pivot axis 24 as indicated by a double arrow.

A fixing device 4 according to the invention is configured in order to be moved selectively into a fixed position (clamped position) or a released position (release position). In the fixed position, the casing unit 23 is clamped between the side cheeks 22 and fixed to the carrier unit 20 and the adjusting unit 3 is clamped in the casing unit 23 by the clamping applied via the side cheeks, and thereby fixed in the longitudinal direction. In the released position, the casing unit 23 can be adjusted relative to the carrier unit 20 in the vertical direction H and the adjusting unit 3 can be adjusted relative to the casing unit 23 and thereby also relative to the holding unit 3 in the longitudinal direction.

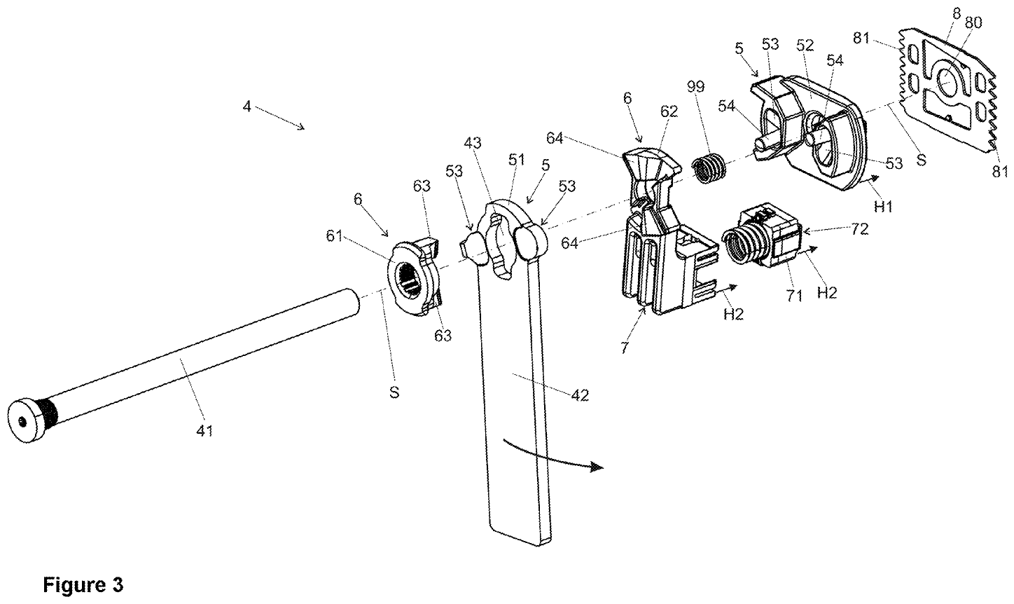

The fixing device 4 has a clamping bolt 41 which extends along a clamping axis S located transversely to the longitudinal axis L, through slots 25 which are elongated in the vertical direction in the two side cheeks 22 and through-openings 26 in the casing unit 23. In FIG. 2, the fixing device 4 is shown pulled apart in an exploded view in the direction of the clamping axis S and pulled out of the holding unit 2, and in FIG. 3 in a similar perspective in a separate view.

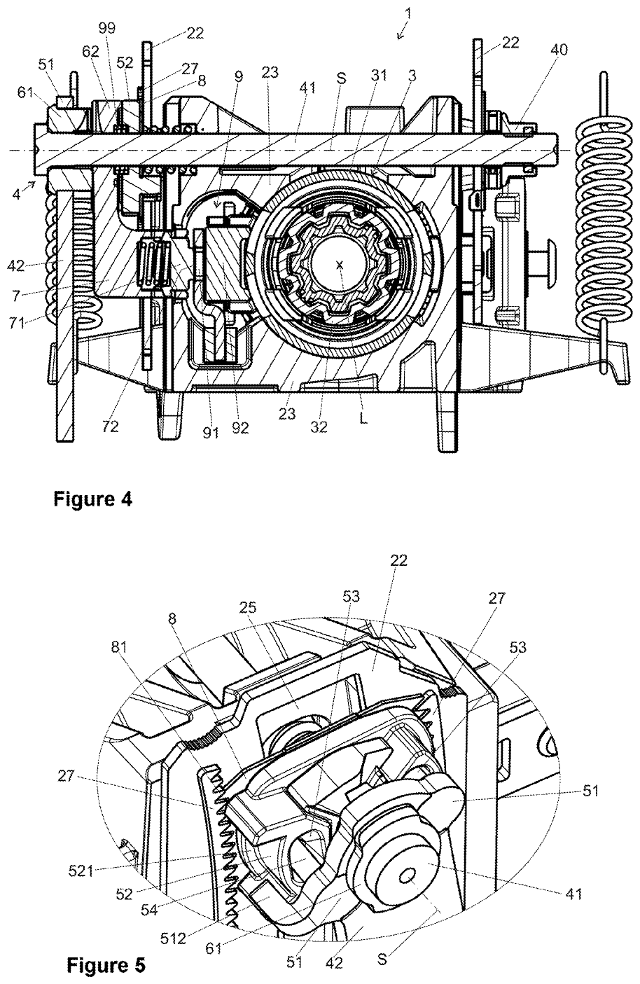

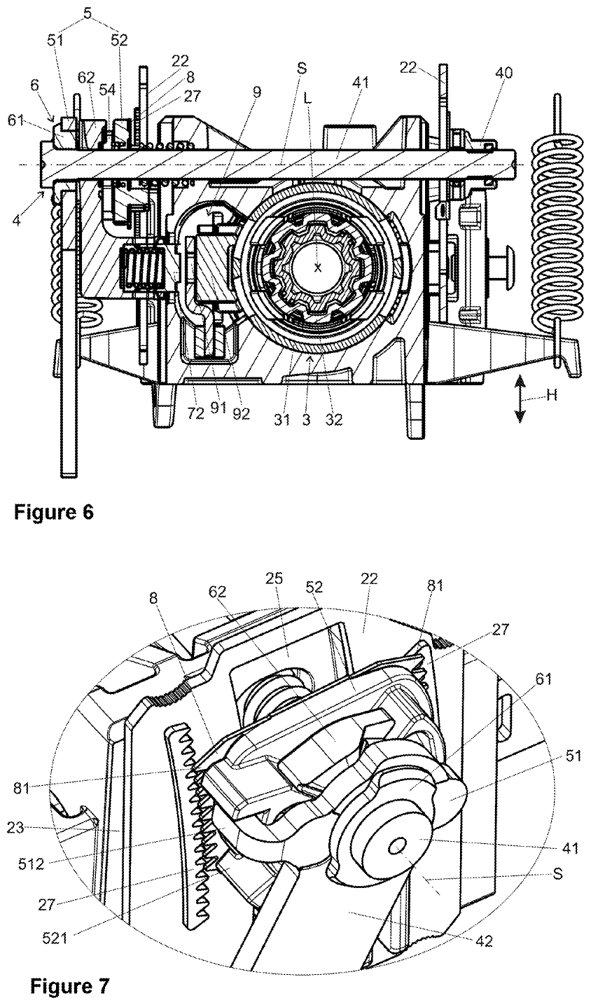

A clamping lever 42 is connected fixedly in terms of rotation to the clamping bolt 41 at the one end facing the observer in FIGS. 2 and 3. In the cross-sectional views of FIGS. 4 and 6, which show a cross section A-A of FIG. 1, the clamping lever 42 is shown to the left. A first clamping device 5 and a second clamping device 6 are arranged between the clamping lever 42 and the side cheek 22 facing the clamping lever 42, and are described in more detail with reference to FIGS. 3, 4 and 6. On the other side cheek 22, the clamping bolt 41 is supported from the outside via an abutment 40, for example a screwed-on nut.

The second clamping device 6 is configured as a cam-connecting link plate device and has a cam plate 61 attached to the clamping bolt 41 fixedly in terms of rotation, and a connecting link plate 62 mounted rotatably movably relative to the clamping bolt 41 and cooperating with the cam plate. The cam plate 61 has axially protruding cams 63 which lie axially against a connecting link track 64 rising in the peripheral direction, and in some portions in the axial direction. In this case, the cams 63 protrude axially through a non-circular opening 43 of the clamping lever, so that the clamping lever 42 is connected in a rotationally fixed manner, i.e. relative to rotation about the clamping axis S, positively to the cam plate 6 and thereby to the clamping bolt 41.

The connecting link plate is connected to a locking element 7 on which a positive connecting element, namely a toothed block 71 oriented toward the side cheek 22, is attached and which has a toothing 72 with teeth running transversely to the longitudinal direction on its front side oriented counter to the longitudinal axis L and thus counter to the adjusting unit 3.

The first clamping device 5 is configured as a tilting pin device and has a stroke-generating plate 51 which is connected fixedly in terms of rotation to the clamping lever 42, for example by an integral design as in the example shown. As described above, this stroke-generating plate 51 is coupled fixedly in terms of rotation to the cam plate 61 of the first clamping device 6 and the clamping bolt 41.

A pressure plate of the first clamping device 5 is rotatably movably mounted between the stroke-generating plate 51 and the side cheek 22 on the clamping bolt 41 relative to the clamping axis S. From their opposingly oriented axial sides the stroke-generating plate 51 and the pressure plate 52 have bearing pockets 53 which are configured as axial recesses and in which the elongated pin-shaped tilting pins are tiltably mounted and supported in the peripheral direction.

On its side remote from the stroke-generating plate 51 the pressure plate lies axially against a toothed plate 8 which is arranged rotatably movably on the clamping bolt 41 relative to the clamping axis S between the pressure plate 52 and the side cheek 22 and which has a bearing bore 80.

The toothed plate 8 has on its outer edges toothings 81 which extend transversely to the clamping axis S and also transversely to the longitudinal axis L and which can be brought axially into engagement in different vertical positions with corresponding internal toothings 27 (see FIG. 2). As a result, the toothed plate 8 together with the clamping bolt 41, which is passed through this toothed plate, can be positively secured in the fixed position relative to a movement along the slots 25 of the side cheeks 22.

An energy absorption device 9 has an engagement element in the form of a toothed plate 91 which is elongated in the longitudinal direction and which has on the outside a toothing with teeth running transversely to the longitudinal axis L. The toothing corresponds to the toothing 72 of the toothed block 71 of the locking element 7 for forming a positive connection which is effective in the longitudinal direction. The toothed plate 91 is attached externally to the adjusting unit 3 via an energy absorption element 92, which is plastically deformed with a relative movement of the toothed plate 91 by energy absorption, for example bent and/or squeezed and/or detached and/or the like and schematically illustrated in the cross section of FIGS. 4 and 6.

The pressure plate 52 and the connecting link plate 62 are held rotatably movably and axially displaceably on the clamping bolt 41. In this case, the pressure plate 52 can have an axial recess 55 in which the connecting link plate 62 is received axially and loosely movable relative to rotation in the intermediate space between the tilting pins 54. As a result, it is possible to implement a nested, particularly compact construction of the two clamping devices 5 and 6. A compression spring 99 is arranged so as to be pretensioned between the pressure plate 52 and the connecting link plate 62, the compression spring pushing apart the pressure plate 52 and the connecting link plate 62, so that the locking element 7 which is connected to the connecting link plate 62 is brought out of engagement in the released position, since the connecting link plate 62 is displaced by the compression spring 99 in the direction of the clamping lever 42 when transferred into the released position.

In order to bring the fixing device 4 into the fixed position shown in FIGS. 4 and 5, the clamping lever 42, as indicated in FIG. 3 with the curved arrow, is pivoted by a predetermined actuating angle about the clamping axis S. In this case, the clamping bolt 41 together with the stroke-generating plate 51 of the first clamping device 5 and the cam plate 61 of the first clamping device 6 is rotated about the clamping axis relative to the holding unit 2. As a result, the pressure plate 52 of the first clamping device 5 is pressed by a clamping stroke H1 from the outside against the side cheek 22 (see FIG. 3 and FIG. 6). Via the abutment, the exerted clamping force is transmitted to the other side cheek 22 so that these side cheeks are pressed from both sides against the casing unit 23 and ensure a non-positive bracing of the casing unit 23 with the carrier unit 20. By the clamping force, the adjusting unit 3 is also clamped non-positively in the casing unit 23 and fixed in the longitudinal direction.

The toothed plate 8 is pushed axially by the pressure plate 52 against the side cheek 22 and at the same time the toothings 81 are brought into positive engagement with the inner toothings 27, for generating a positive securing which is effective in the vertical direction of the toothed plate 8 and the clamping bolt 41 mounted therein.

At the same time, the connecting link plate 62 of the second clamping device 6 is moved axially toward the side cheek 22 by a clamping stroke H2 (see FIG. 3) in the clamping direction. At the same time, the toothed block 71 in the clamping direction penetrates through the slot 25 and is positively supported in this slot 25 in the longitudinal direction on the carrier unit 20. At the same time, the toothed block 71 is brought with its toothing 72 into an effective positive connection with the toothed plate 91 of the energy absorption device 9 in the longitudinal direction.

In the event of a crash, when a very high crash force acts via the steering wheel on the adjusting unit 3 in the longitudinal direction, the holding force of the non-positive connection with the casing unit 23 is overcome and the adjusting unit slips through to the front relative thereto. By the toothed block 71 of the locking element 7 the engagement element 91 (toothed plate) is secured in the longitudinal direction on the side cheek 22, and thereby positively secured on the holding unit 2 in the longitudinal direction. As a result, the toothed plate 91 moves in the longitudinal direction relative to the adjusting unit 3, whereby the energy absorption element 92 is deformed by energy absorption and ensures a controlled braking of the adjusting unit 3.

For setting the steering column 1, the fixing device 4 can be released by reverse actuation of the clamping lever 42. At the same time, the two clamping devices 5 and 6 are released and brought into the release position shown in FIG. 6. As a result, the adjusting unit 3 together with the energy absorption device 9 can be adjusted in the longitudinal direction, and the casing unit 23 together with the fixing device 4 and toothed plate 8 can be adjusted in the vertical direction H relative to the carrier unit. The stroke-generating plate 51 has a projection 512 which extends in the direction of the clamping axis S and which engages in a recess 521 of the pressure plate 52. Since the pressure plate 52 is held fixedly in terms of rotation about the clamping axis S on the side cheek 22, the actuating angle of the clamping lever 41 is defined by the cooperation of the projection 512 and the recess. The stroke-generating plate 51 and the clamping lever 41 can preferably be configured as a one-piece integral component.

### LIST OF REFERENCE SIGNS

1 Steering column
2 Holding unit
20 Carrier unit
21 Fastening means
22 Side cheeks
23 Casing unit
24 Pivot axis
25 Slot
26 Opening
27 Inner toothing
4 Fixing device
40 Abutment
41 Clamping bolt
42 Clamping lever
43 Opening
5 First clamping device
51 Stroke-generating plate
512 Projection
52 Pressure plate
521 Recess
53 Bearing pocket
54 Tilting pin
55 Recess
6 Second clamping device
61 Cam plate
62 Connecting link plate
63 Cam
64 Connecting link track
7 Locking element
71 Toothed block
8 Toothed plate
80 Bearing bore
81 Toothing
9 Energy absorption device
91 Toothed plate
92 Energy absorption element
99 Compression spring
L Longitudinal axis
H Vertical direction
S Clamping axis
H1, H2 Clamping stroke

1.-15. (canceled)

16. A steering column for a motor vehicle, comprising:
an adjusting unit in which a steering spindle is mounted rotatably about a longitudinal axis that extends in a longitudinal direction;
a holding unit in which the adjusting unit is adjustably held; and
a fixing device with a first clamping device and a second clamping device configured to releasably fix the adjusting unit relative to the holding unit, wherein the clamping devices are operatively connected to a clamping lever that is selectively positionable in a fixed position or in a released position, wherein the clamping devices are operatively arranged in parallel.

17. The steering column of claim 16 wherein the first clamping device has a first clamping characteristic and the second clamping device has a second clamping characteristic, wherein the first clamping characteristic and the second clamping characteristic are different.

18. The steering column of claim 17 wherein the first and second clamping characteristics refer to a connection between an actuating path, which is an angle about which the clamping lever is rotated, and a generated clamping stroke.

19. The steering column of claim 16 wherein the first clamping device and the second clamping device have different operating principles.

20. The steering column of claim 16 wherein the first clamping device cooperates with the holding unit to brace the adjusting unit.

21. The steering column of claim 20 wherein the second clamping device cooperates with a locking element to lock the adjusting unit.

22. The steering column of claim 21 wherein the locking element is configured to engage an energy absorption device between the adjusting unit and the holding unit.

23. The steering column of claim 21 wherein the locking element is supported on the holding unit and is configured to engage with an engagement element that is attached to the adjusting unit.

24. The steering column of claim 16 wherein the actuating lever is connected to a clamping bolt.

25. The steering column of claim 16 wherein the first clamping device has a stroke-generating mechanism.

26. The steering column of claim 25 wherein the second clamping device has a tilting pin device.

27. The steering column of claim 25 wherein the second clamping device has a cam-connecting link plate device.

28. The steering column of claim 16 wherein the first clamping device has a tilting pin device, wherein the second clamping device has a cam-connecting link plate device, wherein at least one of:
a pressure plate of the first clamping device is coupled to a connecting link plate of the second clamping device fixedly in terms of rotation relative to a clamping axis; or
a stroke-generating plate of the first clamping device is coupled fixedly in terms of rotation to the clamping lever that is coupled fixedly in terms of rotation to a cam plate of the second clamping device.

29. The steering column of claim 28 wherein the connecting link plate and the pressure plate are braced resiliently against one another.

30. The steering column of claim 16 wherein the holding unit includes a carrier unit that is configured to be secured to a vehicle body.

31. The steering column of claim 16 wherein the holding unit has an outer casing in which the adjusting unit is received so as to be adjustable in the longitudinal direction.

32. The steering column of claim 16 wherein the first clamping device has a tilting pin device, wherein the second clamping device has a cam-connecting link plate device, wherein a stroke-generating plate of the first clamping device is coupled fixedly in terms of rotation to the clamping lever that is coupled fixedly in terms of rotation to a cam plate of the second clamping device.

33. The steering column of claim 16 wherein the first clamping device has a tilting pin device, wherein the second clamping device has a cam-connecting link plate device, wherein a pressure plate of the first clamping device is coupled to a connecting link plate of the second clamping device fixedly in terms of rotation relative to a clamping axis.
